(19) United States
(12) Patent Application Publication
(10) Pub. No.: US 2011/0102631 A1
(43) Pub. Date: May 5, 2011

(54) DIGITAL CAMERA AND METHOD OF CONTROLLING THE SAME

(75) Inventors: Soon-ae Kim, Seongnam-si (KR); Su-gon Baek, Seoul (KR)

(73) Assignee: Samsung Electronics Co., Ltd., Suwon-si (KR)

(21) Appl. No.: 12/915,336

(22) Filed: Oct. 29, 2010

(30) Foreign Application Priority Data
Oct. 30, 2009 (KR) 10-2009-0104210

(51) Int. Cl. H04N 9/73

(52) U.S. Cl. 348/223.1; 348/E09.051

(57) ABSTRACT

A digital camera includes a color shading area detecting unit that detects color shading areas from an entire area of a screen, and a white balance (WB) gain calculating unit that calculates WB gains from available screen areas remaining after excluding the detected color shading areas.

According to a method of controlling the digital camera, WB adjustment is performed by excluding a color shading effect and thus a white balanced image may be generated.

### CROSS-REFERENCE TO RELATED PATENT APPLICATION

This application claims the priority benefit of Korean Patent Application No. 10-2009-0104210, filed on Oct. 30, 2009, in the Korean Intellectual Property Office, the disclosure of which is incorporated herein in its entirety by reference.

### BACKGROUND

1. Field of the Invention

Embodiments relate to a digital camera and a method of controlling the digital camera, and more particularly, to a digital camera which generates a white balanced image by excluding a color shading effect and performing white balance adjustment and a method of controlling the digital camera.

2. Description of the Related Art

In general, people may sense white as being white under any optical source; however, people may view an object as being red or blue according to light from an optical source, for example, sun light, light from a fluorescent lamp, or light from an incandescent lamp, through a camera due to the color temperature of an optical source. If the color temperature is high, an object may be viewed as being blue. If the color temperature is low, an object may be viewed as being red. Accordingly, the colors of an image may not be correctly realized during outputting of the image if affected by the color temperature. A process for adjusting a white subject to appear as being white under light from any optical source and for realizing other colors as being correct colors, in addition to white, may be denoted as white balance adjustment.

In addition, in some cases, the center of the screen is white balanced, whereas surrounding positions of the screen, such as an upper portion and a lower portion of the screen, are not white balanced and thus a green or magenta tint may be viewed. Such a color bleeding phenomenon is denoted as color shading. The color shading is due to a difference in angles of light flowing in a dichroic film of a color separation optical system with respect to a top and a bottom thereof or may be caused due to zooming, changing of an iris, a vignetting characteristic, or use of a lens extender.

In general, auto white balance (AWB) is performed by referring to the entire area of a screen. Also, the entire screen area may include an area distorted by a color shading effect and data thereof may be included in a WB algorithm. As the data of the color shading area is included in the WB algorithm, errors are generated and the entire image may not be white balanced and may be tinted green instead.

### SUMMARY

A digital camera and a method of controlling the digital camera generates a white balanced image by excluding a color shading effect and performs white balance adjustment.

According to an embodiment, a digital camera comprises a color shading area detecting unit that detects color shading areas from the entire area of a screen, and a white balance (WB) gain calculating unit that calculates WB gains from available screen areas remaining after excluding the detected color shading areas.

The digital camera may further include a block dividing unit that divides the entire area of the screen into a plurality of image blocks, wherein the color shading area detecting unit performs detecting of the color shading areas with respect to each image block.

The color shading area detecting unit may compare color information of each image block with color information of image blocks at a center of the screen and determine image blocks having a relatively high color deviation with respect to the color information of the image blocks at the center of the screen as color shading areas.

For example, when the color deviation between the image blocks and the image blocks at the center is above a predetermined threshold value according to a result of comparing mixture ratios of R, G, B color signals calculated from the image blocks with mixture ratios of R, G, B color signals calculated from the image blocks at the center, the color shading area detecting unit may determine that the image blocks are color shading areas.

The digital camera may further include a WB adjusting unit that adjusts R, G, B color signals for each pixel constituting the screen by using the gains calculated in the WB gain calculating unit.

According to another embodiment, a method of controlling a digital camera includes detecting color shading areas from an entire area of a screen, and calculating white balance (WB) gains from available screen areas remaining after excluding the detected color shading areas.

The method may further include dividing the entire area of the screen into a plurality of image blocks, wherein the detecting of the color shading areas is performed with respect to each of the image blocks.

In the detecting of the color shading areas, color information of each image block may be compared with color information of image blocks at a center of the screen and image blocks having a relatively high color deviation with respect to the color information of the image blocks at the center at the center may be determined as color shading areas.

In the detecting of the color shading areas, when a color deviation between the image blocks and the image blocks at the center is above a predetermined threshold value according to a result of comparing mixture ratios of R, G, B color signals calculated from the image blocks with mixture ratios of R, G, B color signals calculated from the image blocks at the center, the image blocks may be determined as color shading areas.

The method may further include adjusting WB for R, G, B color signals for each pixel constituting the screen by using the gains calculated in the calculating of the WB gains.

### BRIEF DESCRIPTION OF THE DRAWINGS

The above and other features and advantages will become more apparent by describing in detail exemplary embodiments with reference to the attached drawings in which:

FIG. 1 is a block diagram of a digital camera, according to an embodiment;

FIGS. 2 and 3 are exemplary views illustrating image division through which an input screen is divided into a plurality of image blocks;

FIG. 4 is an exemplary view illustrating a screen being divided into four areas and white balance (WB) gains calculated for each of the divided areas; and

FIG. 5 is a flowchart illustrating a method of performing white balance (WB) adjustment in a digital camera, according to an embodiment.

### DETAILED DESCRIPTION

Hereinafter, one or more embodiments will be described more fully with reference to the accompanying drawings. Throughout the specification, a digital camera, which is a digital mobile device having functions appropriate for capturing an image, denotes not only a camera classified simply based on a configuration characteristic but also all portable digital devices that capture images, e.g., camcorders, cellular phones, and personal digital assistants (PDA).

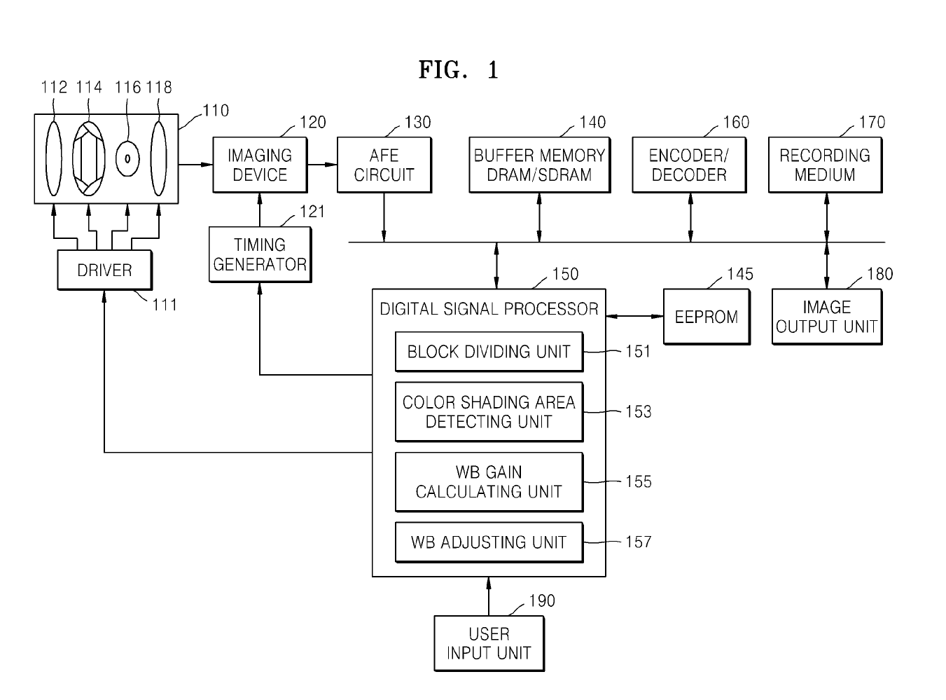

FIG. 1 is a block diagram of a digital camera, according to an embodiment. Referring to FIG. 1, the digital camera includes an optical unit 110 including a plurality of optical lenses for forming an image of an object on an imaging surface, an imaging device 120 for converting the image of the object passing through the optical unit 110 to electrical image signals, an analog front end (AFE) circuit 130 for processing the electrical image signals output from the imaging device 120 and converting the output signals to quantized digital image signals, a buffer memory 140 for temporarily storing the digital image signals so as to provide a processing area for image processing, a recording medium 170 for storing image data of the object as a still image file or a moving picture file, and a digital signal processor 150 for generally controlling overall data flow and each of the elements constituting the digital camera. In addition, the digital camera may further include a user input unit 190 including a plurality of input mechanisms for sensing manipulation of the digital camera by a user as input devices and an image output unit 180 for receiving image processed image signals from the digital signal processor 150 and displaying the received image signals on a screen.

The optical unit 110 includes a zoom lens 112 that may move back and forth along an optical axis to change a focal distance, a shutter 114 and an iris 116 for adjusting an exposure time and an amount of incident light of the imaging device 120, respectively, and a focusing lens 118 for adjusting a focal point of the object image formed on the imaging device 120. A capturing operation of the optical unit 110 may be controlled by the digital signal processor 150 by adding a driver 111.

The imaging device 120 is, for example, a charge-coupled device (CCD) or a complementary metal-oxide semiconductor (CMOS) image sensor, and converts the image of the object that has passed through the optical unit 100 and is incident on the imaging device 120 to electrical image signals.

The imaging device 120 may be controlled by the digital signal processor 150 by adding a timing generator (TG) 121.

The AFE circuit 130 performs a correlated double sampling (CDS) process and an analog digital conversion (ADC) process on the output signals of the imaging device 120 so as to convert the analog image signals output from the imaging device 120 to digital image signals. The digital image signals are transferred to an encoder/decoder 160, are converted to coded data according to a predetermined compression method, and are stored in the recording medium 170. The buffer memory 140 may be a non-volatile memory such as a dynamic random access memory (DRAM) or a synchronous dynamic random access memory (SDRAM) that provides a process area for processing data for the encoder/decoder 160 and the digital signal processor 150.

The digital signal processor 150 executes programs recorded in an electrically erasable and programmable read-only memory (EEPROM) 145, and generally controls operations of the digital camera such as image capturing and image data processing. The digital signal processor 150 adjusts gains for R, G, B color signals that constitute digital image signals so as to perform white balance (WB) adjustment for excluding an effect due to light from optical sources (for example, sun light, light from a fluorescent lamp, and light from an incandescent lamp) and for realizing correct colors. In particular, the digital signal processor 150 detects a color shading area from the entire area of a screen, calculates WB gains by referring to available screen area remaining after excluding the detected color shading area, and thereby may perform correct WB adjustment. That is, the digital signal processor 150 excludes image portions distorted by a color shading effect when calculating WB gains, corrects R, G, B color signals of each pixel signal according to the calculated WB gains, and thereby generates white balanced color signals.

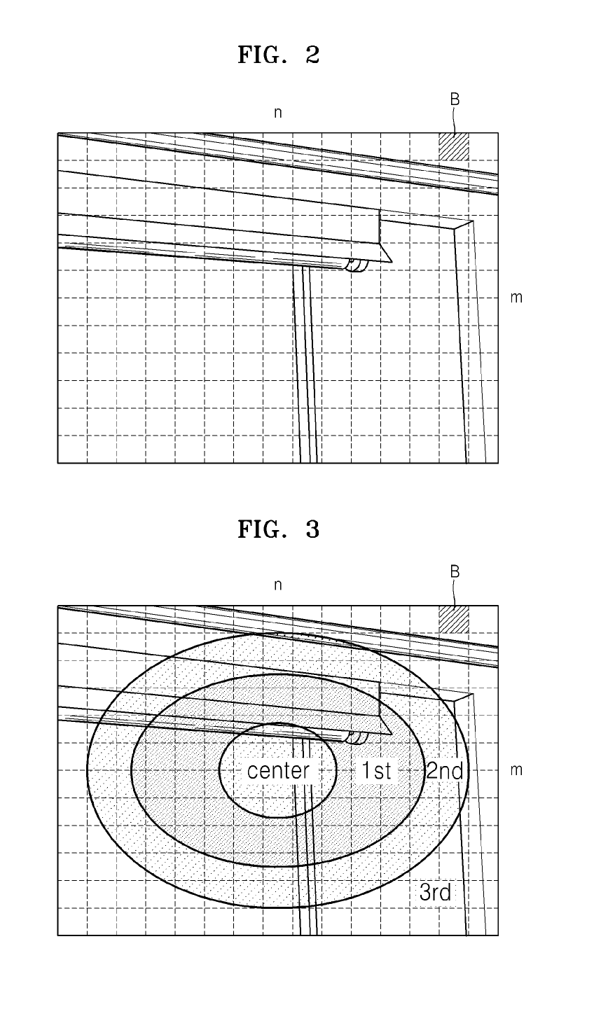

With regard to the WB adjustment, the digital signal processor 150 includes a block dividing unit 151, a color shading area detecting unit 153, a WB gain calculating unit 155, and a WB adjusting unit 157. The block dividing unit 151 divides an input image into a plurality of image blocks B. FIGS. 2 and 3 are exemplary views illustrating image division through which an input screen is divided into a plurality of image blocks. As illustrated in FIGS. 2 and 3, one screen may be divided into n×m image blocks B, for example, 15×12 image blocks B. Here, each image block B includes a plurality of pixels and image processing is performed for each image block B, instead of each pixel, thereby reducing calculation time.

The color shading area detecting unit 153 detects areas that correspond to a color shading condition from the entire screen area. More specifically, the color shading area detecting unit 153 determines that image blocks B having a relatively high color deviation with respect to the image blocks at the center are color shading areas.

In general, light passing through an optical system behaves differently at an optical center compared to at the surroundings. When color shading occurs, color is not uniform between the center and the edge of an image and a color deviation error is dependent on screen position. That is, color is correctly realized at the optical center, whereas color distorted by interference due to an optical system is realized at the surroundings. That is, there is a high possibility that color shading occurs at, for example, a third area (FIG. 3), that is, the edges of the screen.

Color information of the center may be compared with color information of the surroundings so as to detect color shading areas, and WB gains are calculated by excluding the detected color shading areas, thereby performing accurate WB adjustment. More specifically, the color shading area detecting unit 153 calculates color information about the image blocks B set at the center of the screen and the image blocks B set at the surroundings, for example, a mixture ratio of R, G, B color signals (such as a ratio of R/G color signals or a ratio of B/G color signals). For example, as illustrated in FIG. 3, the color information about the image blocks B set at the center may be averaged and stored as the color information of the center.

The color shading area detecting unit 153 shifts the image blocks B in a block unit, compares the color information of the corresponding image blocks B with the color information of the image blocks B set at the center, selects the image blocks B having a relatively high color deviation with respect to a predetermined threshold value, and determines that the selected image blocks B are color shading areas. For example, the color shading area detecting unit 153 calculates a mixture ratio of R, G, B color signals (such as a ratio of R/G color signals or a ratio of B/G color signals) in each image block B and compares the calculated mixture ratio with a mixture ratio of R, G, B color signals at the center. Then, when a color deviation between the image blocks B and the image blocks B set at the center is above a predetermined threshold value, the corresponding image blocks B are recognized as color shading areas.

For example, if the ratio of R, G, B color signals at the center is 1:1:1 (R/G=1, B/G=1) and the color ratio of the noticed image blocks B is within the range of 1±α, it may be determined that the corresponding image blocks B are not color shading areas. If not within the range of 1±α, it may be determined that the image blocks B are color shading areas. For example, if 1−α≦R/G≦1+α and 1−α≦B/G≦1−α, it may be determined that the corresponding image blocks B are not color shading areas. If the image blocks B are not within the above ranges, it may be determined that the image blocks B are color shading areas.

The WB gain calculating unit 155 calculates the WB gains from available screen areas remaining after excluding the recognized color shading areas. More specifically, the WB gain calculating unit 155 may calculate the WB gains for each R, G, B color signal in such a way that white balanced R, G, B color signals calculated in the available screen areas remaining after excluding the color shading areas may be in a mixture ratio of 1:1:1. For example, a WB gain for an R signal may be obtained by dividing a value of G signal by a value of R signal and a WB gain for a B signal may be obtained by dividing a value of G signal by a value of B signal.

The WB adjusting unit 157 adjusts the gains for R, G, B color signals for each pixel by using the calculated WB gains. For example, the WB adjusting unit 157 multiplies the WB gains with the R, G, B color signals for each pixel and generates white balanced R, G, B color signals, thereby performing WB adjustment.

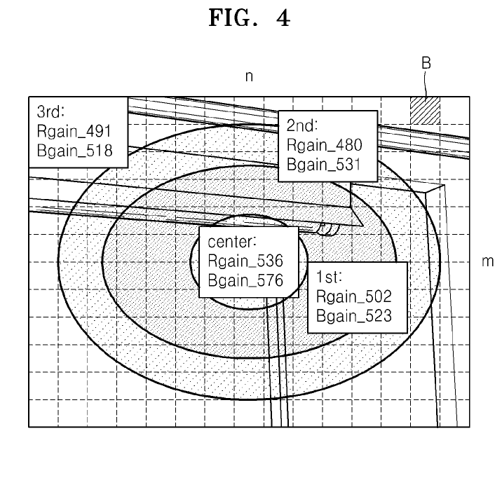

FIG. 4 is an exemplary view illustrating a screen being divided into four areas and white balance (WB) gains calculated for each of the divided areas. In FIG. 4, the entire screen is divided into four areas according to a distance from the center, that is, the center, a first area, a second area, and a third area, and WB gains are calculated for each of the areas (the center, the first area, the second area, and the third area). In FIG. 4, Rgain represents a WB gain for an R signal and Bgain represents a WB gain for a B signal. The WB gains Rgain and Bgain are reduced in the surroundings (first, second, and third areas) which are susceptible to color shading compared with the center. As further from the center, the WB gains are reduced.

If the WB gains are calculated from the entire screen, Rgain of 496 and Bgain of 528, which are lower than Rgain of 536 and Bgain of 576 at the center, are obtained. Since the edge of the screen (e.g. the third area) shows a low WB gain, the average WB gains calculated from the entire screen are biased to the lower WB gain of the edge of a screen (e.g. the third area). Accordingly, in prior art where WB gains are calculated from the entire screen including areas of color shading, color of the entire image may be tinted green. However, in the embodiment, color information of the center is compared with color information of ambient positions so as to detect color shading areas, calculate WB gains from available screen area remaining after excluding the detected color shading areas, perform accurate WB adjustment, and generate a white balanced image.

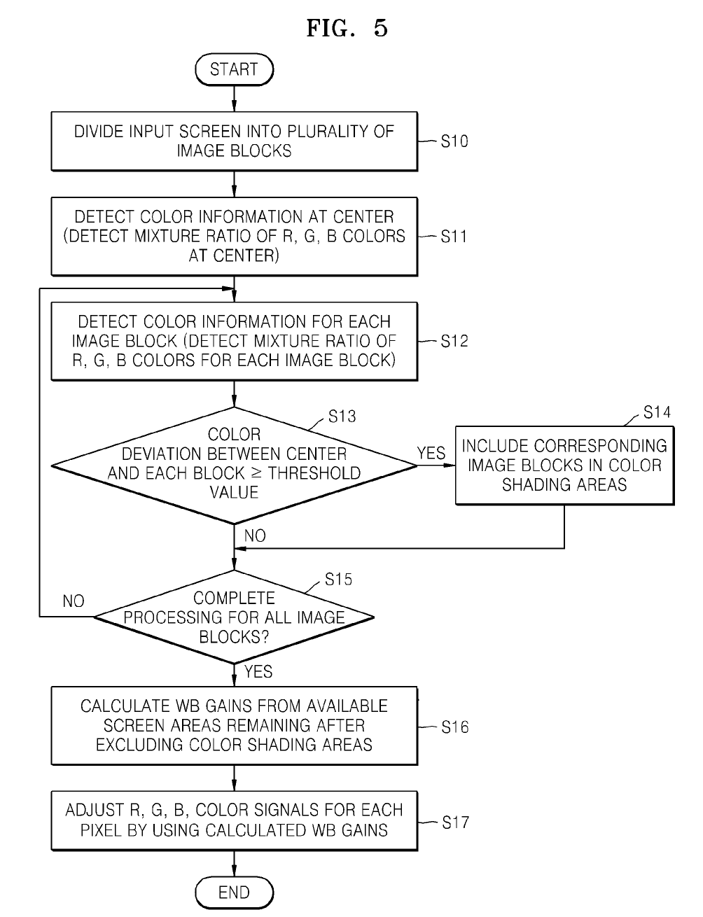

FIG. 5 is a flowchart illustrating a method of performing WB adjustment in a digital camera, according to an embodiment. In operation S10, the digital signal processor 150 divides one screen into a plurality of image blocks B, for example, m×n image blocks B. Here, each image block B includes a plurality of pixels and image processing is performed for each image block B, thereby reducing calculation time.

Then, in operations S11 through S15, color shading areas are detected from the entire screen.

In operation S11, color information of the center is calculated, for example, a mixture ratio of R, G, B colors (e.g., a ratio of R/G color signals or a ratio of B/G color signals) for the center is calculated. Then, in operation S12, color information of each image block B is calculated, for example, a mixture ratio of R, G, B colors (e.g., a ratio of R/G color signals or a ratio of B/G color signals) for each image block B is calculated. In operation S13, the color information of each image block B is compared with the color information of the center and in operation S14, image blocks B having a relatively high color deviation with respect to the image blocks B at the center are determined as color shading areas. That is, the digital signal processor 150 calculates the mixture ratio of R, G, B colors (that is, the ratio of R/G color signals or the ratio of B/G color signals) for each image block B, in operation S12, and compares the mixture ratio of R, G, B colors for each image block B with the mixture ratio of R, G, B colors at the center, in operation S13. Then, if it is determined that a color deviation between each of the image blocks B and the image blocks B at the center is above a predetermined threshold value, the corresponding image blocks B are recognized as color shading areas, in operation S14.

For example, if the color ratio of R, G, B colors at the center is 1:1:1 (R/G=1, B/G=1) and the color ratio of the image blocks B is within the range of 1±α, that is, 1−αR≦/G≦1+α and 1−αB≦/G≦1+α, it may be determined that the corresponding image blocks B are not color shading areas. If the color ratios of the image blocks B are not within the above ranges and have a relatively high color deviation with respect to the center, it may be determined that the image blocks B are color shading areas. Operations S12 through S14 may be performed for each image block B and may be repeatedly performed until all image blocks B are processed, in operation S15.

Then, in operation S16, WB gains are calculated from available screen areas remaining after excluding the color shading areas. The digital signal processor 150 may calculate the WB gains for each R, G, B color signal in such a way that white balanced R, G, B color signals calculated in the available screen areas remaining after excluding the color shading areas may be in a mixture ratio of 1:1:1.

In operation S17, the gains for R, G, B color signals for each pixel are adjusted by using the WB gains calculated in operation S16. For example, the WB gains are multiplied by R, G, B color signals for each pixel and white balanced R, G, B color signals are generated, thereby performing WB adjustment.

According to embodiments of the digital camera and the method of controlling the digital camera, color information in the screen is referred to in order to detect color shading areas distorted by a color shading effect and WB gains are calculated by excluding the color shading areas. Accordingly, accurate WB adjustment may be possible and a white balanced image may be generated.

A program for executing methods of controlling digital cameras according to the present embodiment and embodiments modified thereof may be stored in a non-transitory computer readable recording medium. Here, the recording medium may be either the EEPROM 145 as shown in FIG. 1, for example, or other recording media. Any processes may be implemented as software modules or algorithms, and may be stored as program instructions or computer readable codes executable on a processor on a non-transitory computer-readable storage media such as flash memory, read-only memory (ROM), random-access memory (RAM), CD-ROM's, DVD's, magnetic tapes, floppy disks, hard disks, and optical data storage devices. The computer readable storage medium can also be distributed over network coupled computer systems so that the computer readable code is stored and executed in a distributed fashion. This computer readable code can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

While the invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital camera comprising:
a color shading area detecting unit that detects color shading areas from an entire area of a screen; and
a white balance (WB) gain calculating unit that calculates WB gains from available screen areas remaining after excluding the detected color shading areas.

2. The digital camera of claim 1, further comprising a block dividing unit that divides the entire area of the screen into a plurality of image blocks, wherein the color shading area detecting unit performs detecting of the color shading areas with respect to each image block.

3. The digital camera of claim 2, wherein the color shading area detecting unit compares color information of each image block with color information of image blocks at a center of the screen and determines image blocks having a relatively high color deviation with respect to the color information of the image blocks at the center of the screen as color shading areas.

4. The digital camera of claim 3, wherein, when the color deviation between the image blocks and the image blocks at the center is above a predetermined threshold value according to a result of comparing mixture ratios of R, G, B color signals calculated from the image blocks with mixture ratios of R, G, B color signals calculated from the image blocks at the center, the color shading area detecting unit determines that the image blocks are color shading areas.

5. The digital camera of claim 1, further comprising a WB adjusting unit that adjusts R, G, B color signals for each pixel constituting the screen by using the gains calculated in the WB gain calculating unit.

6. A method of controlling a digital camera, the method comprising:
detecting color shading areas from an entire area of a screen; and
calculating white balance (WB) gains from available screen areas remaining after excluding the detected color shading areas.

7. The method of claim 6, further comprising dividing the entire area of the screen into a plurality of image blocks, wherein the detecting of the color shading areas is performed with respect to each of the image blocks.

8. The method of claim 7, wherein in the detecting of the color shading areas, color information of each image block is compared with color information of image blocks at a center of the screen and image blocks having a relatively high color deviation with respect to the color information of the image blocks at the center of the screen are determined as color shading areas.

9. The method of claim 8, wherein, in the detecting of the color shading areas, when a color deviation between the image blocks and the image blocks at the center is above a predetermined threshold value according to a result of comparing mixture ratios of R, G, B color signals calculated from the image blocks with mixture ratios of R, G, B color signals calculated from the image blocks at the center, the image blocks are determined as color shading areas.

10. The method of claim 6, further comprising adjusting WB for R, G, B color signals for each pixel constituting the screen by using the gains calculated in the calculating of the WB gains.
